(19) United States
(12) Patent Application Publication
(10) Pub. No.: US 2014/0273912 A1
(43) Pub. Date: Sep. 18, 2014

(54) User Configurable Emergency Alert System for Mobile Wireless Devices

(71) Applicants: Guat Chai Peh, Penang (MY); Shuh Shyan Koh, Penang (MY)

(72) Inventors: Guat Chai Peh, Penang (MY); Shuh Shyan Koh, Penang (MY)

(21) Appl. No.: 13/976,593

(22) PCT Filed: Mar. 15, 2013
(86) PCT No.: PCT/US2013/032715

§ 371 Date: Jun. 27, 2013

(51) Int. Cl. H04W 4/22

(52) U.S. Cl. CPC H04W 4/22
USPC 455/404.1

(57) ABSTRACT

An emergency alert system of an aspect includes an emergency alert system configuration module to allow a user to configure a phone number to which an emergency alert is to be sent. The system also includes a touchscreen interface module to receive an indication from a user, through a touchscreen display device, that the emergency alert is to be sent. The system also includes an emergency alert module coupled with the touchscreen interface module. The emergency alert module, in response to the indication, is to cause the emergency alert to be sent to the user configured phone number through a wireless signal that is to be transmitted by an antenna.

### BACKGROUND

1. Technical Field

Embodiments described herein generally relate to emergency alert systems. In particular, embodiments described herein generally relate to emergency alert systems for mobile wireless devices.

2. Background Information

It is often desirable for a person to be able to alert or notify another person, organization, or entity in the event of an emergency. For example, this may be the case for an elderly person living at home. The elderly person may potentially fall, have a medical emergency (e.g., a heart attack), become lost or severely disoriented due to Alzheimer's disease or dementia, or otherwise need emergency help. Often, the elderly people live alone and may not have help readily available. Moreover, emergencies are not limited to just elderly people. Rather, this may also be the case for people with certain medical conditions. A few examples of such medical conditions include, but are not limited to, allergic reactions, heart problems, diabetes, seizures, autism, or other medical and/or mental conditions. Still further, this may also be the case in other emergency situations, such as, for example, serious car accidents, muggings, robberies, attempted kidnappings, and the like. In general, there is a great need in the art for people to be able to alert or notify others in the event of a wide variety of different types of emergencies.

One challenge is that the conventional ways for people to alert or notify others during such emergencies tend to be limited and to have certain drawbacks. One conventional way is for the person to dial a fixed or dedicated emergency number. For example, in the United States the person may dial the three-digit emergency number “911” on their phone. Such an approach is often used for various different types of emergencies (e.g., to reach an ambulance for medical help, to reach the police, to reach the fire department, etc.). The dialing of the emergency number may connect the person with a representative who may attempt to obtain details about the type of emergency, the location of the person, details about the emergency, and the like, by speaking with the person, so that they may redirect the emergency alert to the appropriate entity that will respond to the emergency. The dialing of the emergency number by itself does not indicate the type of emergency and is not directed to the entity that will respond to the emergency. As a result, this approach may tend to be slow in getting the alert to the entity who will respond. Moreover, this approach requires active involvement by the person experiencing the emergency and may not be effective when the person is unable to adequately describe the emergency (e.g., because they are unconscious, incoherent, injured, disoriented, prevented from doing so by a mugger or kidnapper, etc.).

Another conventional way for people to alert or notify others during emergencies is for the people as service subscribers to have fixed point-to-point wired connections with health care providers as service providers. For example, a resident of an assisted living facility or so-called old folks home may have a fixed point-to-point wired connection from their residence to a health care provider. However, this is a wired connection and is generally not useful when the person is not at their residence or otherwise able to access the fixed point-to-point connection. Moreover, this approach generally tends to be inflexible in that it only notifies the service provider.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating an overall environment in which embodiments of the invention may be used.

FIG. 2 is a block flow diagram of an embodiment of a method of configurable emergency alert.

FIG. 3 is a block diagram of an embodiment of a mobile wireless device that is suitable for implementing embodiments of emergency alert systems.

FIG. 4 is a block diagram of an embodiment of a configurable emergency alert system coupled with various other conventional logic and hardware of a mobile wireless device.

FIG. 5 is a block diagram illustrating an embodiment of a user configuration interface that may be presented on a display device to allow a user to configure a configurable emergency alert system.

FIG. 6 illustrates an example embodiment of operation of a configurable emergency alert system.

### DETAILED DESCRIPTION OF EMBODIMENTS

Disclosed herein are user configurable emergency alert systems for mobile wireless devices. In the following description, numerous specific details are set forth (e.g., specific types of emergency alerts, emergency alert system capabilities, types of configuration data, types of messages and message content, logic implementations, sequences of operations, logic partitioning/integration details, types and interrelationships of system components, etc.). However, it is understood that embodiments of the invention may be practiced without these specific details. In other instances, well-known circuits, structures and techniques have not been shown in detail in order not to obscure the understanding of this description.

FIG. 1 is a block diagram illustrating an overall environment 100 in which embodiments of the invention may be used. A person or user 101 has a mobile wireless device 102 having an embodiment of a configurable emergency alert system 103. By way of example, the person or user may represent an elderly person, a person with certain significant medical conditions (e.g., allergic reactions, heart problems, diabetes, autism, or other medical and/or mental conditions), or any other person desiring to use the emergency alert system.

The mobile wireless device is mobile. Typically, the mobile wireless device is sufficiently small to be carried around by the user when the user moves around and has a battery or other portable or mobile source of power. The mobile wireless device also typically has a wireless cellular modem and/or WiFi modem and antenna. The mobile wireless device is operable to establish wireless connections with a network 107. By way of example, the device may establish connection through a cellular or WiFi network to the Internet and thereafter through other wired or wireless networks to other phone numbers reachable through the network 107. Examples of suitable mobile wireless devices include, but are not limited to, smartphones, wireless personal digital assistants, wireless handheld computing devices, tablet computers, other one-piece wireless mobile computing devices primarily operated by a touchscreen, cellular phones, and other mobile wireless computing devices known in the arts.

The wireless mobile device 102 includes an embodiment of a configurable emergency alert system 103. The configurable emergency alert system is capable of alerting or notifying others in the event of an emergency and/or when the user triggers the emergency alert system by sending one or more wireless alerts 106 to the network 107. The network 107 may receive, convey, and deliver at least a first alert 108A potentially up through an Nth alert 108N corresponding to the one or more wireless alerts 106. By way of example, in some embodiments, the user may trigger, activate, or cause the configurable emergency alert system to send the wireless alerts by pressing an icon 105 on a touchscreen 104 of the wireless mobile device. In another example, in some embodiments, the user may press on a touch-screen and hold for a period of two to three seconds. Such simple pressing on the touchscreen represents a simple, uncomplicated, easy, and effective mechanism for a user to trigger the alert without significant memorization being involved and without significant procedure or concentration or cognitive thought being involved. Alternatively, other ways of triggering the configurable emergency alert system are contemplated (e.g., using a touch screen to traverse through multiple screens or a user interface, providing a dedicated button on the wireless mobile device, etc.).

In some embodiments, the emergency alert system 103 is a configurable emergency alert system that is capable of being configured by the user (e.g., pre-configured prior to the emergency). Various different ways in which the emergency alert system may be configured by the user according to different embodiments will be described herein. In some embodiments, the emergency alert system may be configurable by the user to alert configurable phone numbers. As shown, in some embodiments, the first alert 108A may be directed to a first configurable phone number 109A which can potentially be any valid phone number, and the Nth alert 108N may be directed to an Nth configurable phone number 109N which can also potentially be any valid phone number.

The configurable phone numbers may be any of many different possible phone numbers that the user may desire to use, such as, for example, those of relatives, friends, neighbors, health care professionals, other trusted individuals, or anyone else the user desires. Advantageously, the numbers are not required to be static three-digit emergency numbers or those of only health care professionals, health service providers, emergency care facilities, or other such institutional or fee-based service providers, unless the user desires that. The choice of phone numbers may be flexible rather than being statically required to be certain numbers (e.g., static three-digit emergency numbers like 911, one or a few particular numbers of fixed point-to-point connections to service providers, one or a few numbers of particular emergency support/help centers, or the like). Advantageously, this may allow the user to customize or personalize the emergency alert system in a way that best fits the emergencies most likely expected by the user, or at least in a way that the user desires. Such personalization, customization, or configuration is not typically available from conventional emergency alert systems known in the art. As one example embodiment, the user may be able to configure the emergency alert system to use a first number of a brother, a second number of a mother, a third number of a friend, and a fourth number of a subscription or institutional emergency responder (e.g., a health care provider, ambulance, emergency number, or the like).

In some embodiments, the one or more wireless alerts 106 and the first alert 108A through potentially the Nth alert 108N may provide one or more details relevant or at least potentially relevant to the emergency alert. For example, in some embodiments, the alerts may provide a configured (e.g., pre-configured) message that the user desires to send. In some embodiments, the message may be a text message, an email message, a voicemail message, or a combination of such different types of messages. The message may provide details relevant or at least potentially relevant to the emergency alert. A few examples of such details include, but are not limited to, a name of the person, an indication that there is an emergency, an indication of medical and/or mental conditions of the person (e.g., allergic reactions, diabetes, Alzheimer's disease or dementia, etc.), an indication of medicines the person is taking, health care provider information (e.g., the persons primary care physician and her contact information), an indication of the persons insurance provider their contact information and the policy number, or the like, or a combination of such different types of information. Such details may be pre-configured by the user prior to the emergency and stored or preserved by the wireless mobile device so that they may be provided autonomously from the device when they are needed. Advantageously, this may avoid the user needing to provide such details verbally (e.g., to a representative associated with a 911 emergency number) and may be especially useful when the user is disoriented or otherwise unable to adequately communicate such details.

In some embodiments, the emergency alert system may autonomously utilize existing conventional hardware resources of the wireless mobile device to provide other details relevant or potentially relevant to the emergency alert. For example, in some embodiments, the emergency alert system may be coupled with a time keeping circuit or logic of the mobile wireless device, may obtain a time from the time keeping circuit or logic, and may autonomously include the time in the emergency alerts. As another example, in some embodiments, the emergency alert system may be coupled with a positioning circuit or logic of the mobile wireless device (e.g., a geographic positioning system), may obtain position information from the positioning circuit or logic, and may autonomously include the positioning information in the emergency alerts. In some embodiments, either local maps or maps available through the network 107 may be autonomously consulted to convert the position information into a location (e.g., a street address). Alternatively, other representations of positions may be used. Advantageously, the emergency alert system may autonomously provide such details so that the user doesn't need to provide such details, which may be especially useful when the user is unable to adequately communicate such details.

FIG. 2 is a block flow diagram of an embodiment of an emergency alert method 270. The emergency alert method may be performed by any of the emergency alert systems disclosed elsewhere herein (e.g., those of FIG. 1, FIG. 3, and/or FIG. 4) or by different emergency alert systems. Specific optional features, aspects, details, and characteristics of those emergency alert systems may also optionally apply to the method 270 which may be performed by and/or within such emergency alert systems. The systems may also perform operations and methods similar to or different than those of FIG. 2.

The emergency alert method includes receiving input from a user through a touchscreen display device and based on the input configuring a phone number to which an emergency alert is to be sent, at block 271. In some embodiments, the phone number may be configured to be any valid phone number. In some embodiments, input may be received from the user to configure multiple different phone numbers each of which is to be sent an emergency alert. In some embodiments, input may be received from the user to configure the emergency alert to include content selected from a medical condition of the user, a medicine the user is taking, a health care provider of the user, contact information for the health care provider of the user, an insurance provider, contact information for the insurance provider, and an insurance policy number of the user.

The emergency alert method includes receiving an indication from the user through the touchscreen display device that the emergency alert is to be sent, at block 272. The emergency alert method includes causing the emergency alert to be sent to the configured phone number through a wireless signal transmitted by an antenna in response to receiving the indication, at block 273. In some embodiments, a location of the mobile wireless device may be autonomously included in the emergency alert.

FIG. 3 is a block diagram of an embodiment of a mobile wireless device 302 that is suitable for implementing embodiments of emergency alert systems. As previously mentioned, examples of suitable mobile wireless devices include, but are not limited to, smartphones, wireless personal digital assistants, wireless handheld computing devices, tablet computers, other one-piece wireless mobile computing devices primarily operated by a touchscreen, cellular phones, and other mobile wireless computing devices known in the arts.

The mobile wireless device includes a memory 310. The memory may represent one or more memories, of potentially different types, such as, for example, various types of dynamic random access memory (DRAM) or other volatile memory, flash or other types of non-volatile memory, or a combination thereof. In some embodiments, the memory may store an embodiment of a configurable emergency alert system 303-1 or at least a portion thereof (e.g., one or more modules thereof). In some embodiments, the configurable emergency alert system 303-1 may include a software application and/or software code and/or a set of instructions that may be executed or run on the mobile wireless device.

An application processor system on chip (SoC) 311 is coupled with the memory 310. The application processor SoC includes a processor 312. In some embodiments, the processor includes configurable emergency alert system logic 303-2. In some embodiments, the processor may execute a software application, code, or a set of instructions to configure or enable the processor to have the configurable emergency alert system logic. The application, code, or set of instructions if or when executed or run by the processor may be operable to cause the processor to implement a configurable emergency alert system as disclosed elsewhere herein and/or to perform one or more configurable emergency alert operations or methods. In other embodiments, the processor may have dedicated configurable emergency alert system logic, such as, for example, hardware (e.g., transistors, integrated circuitry, etc.), firmware (e.g., microinstructions or other low-level instructions stored in non-volatile memory), software, or various combinations thereof.

A touch screen display device and touch screen controller 304 is coupled with the application processor SoC 311. A touch screen display device and controller are operable to display data, pictures, objects, graphics, user interfaces, and the like, to the user. In some embodiments, the touch screen display device and controller may be operable to display an icon 305 for the configurable emergency alert system to the user on the touch screen display. As mentioned, the icon is one way for the user to trigger or activate the emergency alert system. In another embodiment, pressing on the touchscreen for a period of time (e.g., two to three seconds) may optionally represent another possible way to trigger the emergency alert system whether the mobile wireless device is active, locked, or asleep. In some embodiments, even pressing on a portion of the touchscreen that does not have the icon 305 of the emergency alert system for such a prolonged period of time may be operable to trigger the emergency alert system. In some embodiments, even pressing on an icon for another application besides the icon 305 for the emergency alert system for such a prolonged period of time may be operable to trigger the emergency alert system. Commonly, pressing on an icon of an application for shorter periods (e.g., often less than about a second) activates the icon, but in some embodiments, pressing for a longer time period of time two to three seconds may be interpreted differently as a trigger of the emergency alert. In the case of a cellular phone without a touchscreen, prolonged pressing (e.g., for around three seconds or more) on a given one, or any of the buttons of a keypad, represents a possible way to trigger the emergency alert system, which may be implemented in hardware, firmware, software, or a combination thereof within the cellular phone. In some embodiments, if the user unintentionally triggers the emergency alert system, a mechanism may be provided to allow the user to stop the emergency alert. Advantageously, these represent simple and easy to use ways for the user to trigger the emergency alert that tend to be effective even when the user is disoriented, confused, sick, or the like. Not much memorization of procedure or cognitive ability to activate the alert is needed.

The touch screen display device and controller are also operable to allow the user to enter data (e.g., keypad type alphanumeric data entries) and/or selections through the touch screen display (e.g., selecting buttons, dragging and dropping items on the display, sliding items or objects on the display, etc.). In some embodiments, configuration data for the configurable emergency alert system may be entered through the touch screen display device and controller. For example, in some embodiments, the configurable emergency alert system may include a configuration interface, program, or module to allow the user to enter the configuration data or configuration information.

A baseband processor 313 is coupled with the application processor SoC 311. The baseband processor may also be referred to as a baseband radio processor or radio processor. The baseband processor may represent a chip, part of a chip, or other device that is operable to perform or manage radio functions involving one or more antennas. In some embodiments, the baseband processor may include its own memory (not shown). A cellular transceiver 314 is coupled with the baseband processor and a first antenna 315. The cellular transceiver may be operable to exchange signals with a cellular network (e.g., with a base station) through the first antenna. By way of example, the cellular transceiver may represent a 3G or 4G compliant cellular transceiver, or a subsequent version of such a cellular transceiver. A WiFi and/or Bluetooth transceiver 316 is coupled with the baseband processor and a second antenna 317. The WiFi and/or Bluetooth transceiver may be operable to exchange wireless signals with a wireless local area network (e.g., a local wireless router) through the second antenna. In some embodiments, either the cellular transceiver or the WiFi and/or Bluetooth transceiver, or both, may be used to deliver wireless emergency alerts to a network (e.g., the emergency alerts 106 to the network 107 as shown in FIG. 1).

A geographic positioning system (GPS) transceiver 318 is coupled with the baseband processor and a third antenna 319. The GPS transceiver may be operable to determine a position or location of the mobile wireless device through signals exchanged over the third antenna. In some embodiments, the configurable emergency alert system may optionally be coupled with the GPS transceiver, or optionally coupled with data (e.g., position or location information) provided by the GPS transceiver, and may optionally be operable to include the position or location information in the emergency alert messages. Alternatively, the GPS is optional and may optionally be omitted in some embodiments (e.g., in a cellular phone implementation where a simpler or less expensive implementation is desired and/or where an existing GPS system is not as readily available). A timing unit 320 is coupled with the application processor SoC 311. The timing unit is operable to keep time. In some embodiments, the configurable emergency alert system may optionally be coupled with the timing unit, or optionally coupled with data (e.g., a time) provided by the timing unit, and may optionally be operable to include the time in the emergency alert messages.

An audio device 321 is coupled with the application processor SoC 311. In one aspect, the audio device may represent an audio codec. As is known, a codec or coder-decoder represents a device that is capable of encoding and decoding data streams or signals. Alternatively, the audio device may represent another type of audio processor or chip. A speaker 322 and a microphone 323 are coupled with the audio device. In some embodiments, the user may pre-record a voice message using the microphone and the pre-recorded voice message may be autonomously delivered by the mobile wireless device as part of a wireless emergency alert. For example, the pre-recorded voice message may be read to a friend of the user reachable by a pre-configured phone number.

A power unit 324 is also coupled with the application processor 311. The power unit is operable to provide power to the mobile wireless device. The power unit is coupled with a battery 325 from which the power may be supplied. The power unit may also generally be operable to manage power in the mobile wireless device. This may potentially include putting components to sleep, gating voltages, etc. Any conventional power management approaches known in the art for mobile wireless devices are potentially suitable. In some embodiments, the configurable emergency alert system may optionally be capable of operating in the background even when the mobile wireless device is in a sleep state, inactive state, or other such low power non-operational state. For example, in some embodiments, a mechanism similar to those by which conventional smartphones and other electronic devices are woken from sleep, inactive, or other low-power non-operational sates based on user activity may be utilized to trigger the emergency alert system. This may be done in hardware, firmware, software, or a combination thereof. For example, in some embodiments, hardware and/or firmware logic may be designed into a processor or integrated circuit of the mobile wireless device to detect such trigger events even when the device is asleep. As another example, in some embodiments, the mobile wireless device may have a daemon or background process that is operable to run in the background to detect such trigger events even when the device is asleep.

It is to be appreciated that this is just one illustrative example of a suitable mobile wireless device configuration, and that the invention is not limited to just this particular mobile wireless device configuration. In other embodiments, a lesser or more equipped mobile wireless device may be used instead. For example, other embodiments may optionally omit the GPS transceiver, either one of the WiFi/Bluetooth or cellular transceivers, the touchscreen aspect, or some combination thereof. The configuration of the system, including the number of components included, may vary from one implementation to another depending upon various factors, such as performance goals, price constraints, number of features desired to be supported, etc. In other embodiments, where multiple components have been described they may instead be incorporated into a single component and/or where a single component has been described it may instead be partitioned into multiple components. For example, some or all of one or more of the memory 310, the baseband processor 313, and/or the audio device 321 may be integrated on-chip with the application processor SoC 311. In general, either circuitry may be integrated together on a larger SoC or the SoC may be partitioned into multiple chips. Moreover, other embodiments may couple or arrange the components differently. In general, any configuration known to be suitable for mobile wireless devices should also be suitable for embodiments herein.

FIG. 4 is a block diagram of an embodiment of a configurable emergency alert system 403 coupled with various other conventional logic and hardware 404, 420, 418, 441, 443, 415 of a mobile wireless device. The configurable emergency alert system includes an emergency alert system manager module 430. The emergency alert system manager module is operable to control and/or manage the operation and functioning of the other modules of the configurable emergency alert system.

An emergency alert system configuration module 431 is coupled with the emergency alert system manager module 430 and with a touch screen interface module 432. The emergency alert system configuration module is operable to provide a way for the user to configure the emergency alert system. In some embodiments, the emergency alert system configuration module may include one or more configuration interfaces 433 that may be presented to the user on the touch screen display to allow the user to configure the emergency alert system. Examples of suitable interfaces will be discussed further below.

Based on the user input, the emergency alert system configuration module may be operable to store or otherwise preserve emergency alert system configuration data 434. As shown, in some embodiments, the emergency alert system configuration data may include one or more text numbers 435, a text message alert 436 to be delivered to each of the one or more text numbers, one or more phone numbers 437, a phone or voice message 438 to be delivered to one or more or each of the phone numbers, and optionally one or more other configurations or preferences 439.

The touch screen interface module 432 is also coupled with the emergency alert system manager module 430. The touch screen interface module is also operable to be coupled with a touch screen display device 404. In some embodiments, the touch screen interface module may include an emergency alert icon 405 to be presented on the touch screen display device. The touch screen icon represents one way in which the user may trigger, activate, or otherwise cause the emergency alert system to send alerts. In some embodiments, the touch screen interface module may also optionally be configured to recognize a user pressing on the touchscreen display for a period of time (e.g., several seconds) as an indication to send the alerts, in some cases, even if the mobile wireless device is locked or asleep, although this is not required.

In some embodiments, when the icon is pressed, or the emergency alert system is otherwise triggered or activated through the touch screen display device, the touchscreen interface module 432 may communicate this to the emergency alert system manager module 430. The emergency alert system manager module is coupled with the emergency alert system configuration data, and may begin to control the emergency alert process as configured by this configuration data. The emergency alert system manager module is coupled with a text messaging emergency alert module 440. The text messaging emergency alert module is coupled with a conventional text messaging service module 441, for example, those used in conventional cell phones and smart phones to provide text messages. In some embodiments, the emergency alert system manager module may cause or control the text messaging emergency alert module to send the pre-configured text message 436 to each of the one or more configured text numbers 435. The conventional text messaging service module 441 may send the texts through an antenna 415.

The emergency alert system manager module is also coupled with a phone messaging emergency alert module 442. The phone messaging emergency alert module is coupled with a conventional phone messaging service module 443, for example, those used in conventional cell phones and smart phones to dial phone numbers and/or attempt to establish phone calls. In some embodiments, the emergency alert system manager module may cause or control the phone messaging emergency alert module to sequentially dial phone numbers from the set of configured phone numbers 437 one at a time in a particular pre-configured order. In some embodiments, if a person answers a call, the emergency alert system manager module may be operable to cause or control the phone messaging emergency alert module to deliver the pre-recorded or pre-configured phone message 438 to the person.

In some embodiments, an emergency alert text message may be sent to all people in the pre-configured alert call list. This is followed by actual phone calls to the pre-configured phone number in the alert call list according to the pre-configured order to call. This is a way to ensure that the alert has been received by the receiver. The configurable emergency alert system may have a capability of distinguishing between phone calls answered by people and phone calls answered by answering machines or voicemail. For example, the emergency alert system of the mobile wireless device may recognize a signal sent by a wireless network indicating whether or not a person answered a phone call, or other approaches known in the arts may be used.

In some embodiments, if all of the configured numbers have been dialed and nobody has answered, the alert system may again loop through the set of configured numbers one or more times until someone eventually answers. In some embodiments, after looping through the set of configured numbers multiple times (e.g., a configured number of times) with nobody answering, the emergency alert system may autonomously try another approach, such as, for example, dialing the emergency number 911 or randomly dialing phone numbers of contacts programmed in the cellular phone. The conventional phone messaging service module 443 may send the phone messages through the antenna 415.

In some embodiments, the emergency alert system manager module 430 may be coupled with a conventional timing unit 420 and/or a conventional GPS transceiver 418 of the mobile wireless device. In some embodiments, the emergency alert system manager module may be operable to receive a time from the timing unit and/or position or location information from the GPS transceiver. In some embodiments, the emergency alert system manager module may include a time and/or location inclusion module 444 that is operable to include the time and/or the position or location in the text messages to be sent out and/or the phone messages to be sent out. In some embodiments, whether to send the time and/or the position in the messages, and whether to send the time and/or position in the text messages or the phone messages, may be pre-configured in the preferences 439. Alternatively, other embodiments of configurable emergency alert systems need not necessarily allow for the possibility of the time and/or the data from the GPS system to be included in the messages.

It is to be appreciated that this is just one illustrative example of a suitable configurable emergency alert system, and that the invention is not limited to just this particular configurable emergency alert system. In other embodiments, a lesser or more equipped configurable emergency alert system may be used instead. For example, as mentioned, the timing information and/or the GPS information need not be included in the messages. As another example, other embodiments may use a different mechanism than a touch screen to interface with the user (e.g., a conventional keypad). As a further example, other embodiments may use text alerts but not phone/voice message alerts, or may use phone/voice message alerts but not text message alerts. Still other embodiments may use email emergency alerts in addition to and/or instead of one or more of the text and/or phone emergency alerts. The particular emergency alert system, including the number of components included, may vary from one implementation to another depending upon various factors, such as performance goals, price constraints, number of features desired to be supported, user preferences, etc. In other embodiments, where multiple components have been described they may instead be incorporated into a single component and/or where a single component has been described it may instead be partitioned into multiple components. For example, the configuration module may be incorporated into the manager module, or the configuration data may be incorporated into either the configuration module or the manager module.

FIG. 5 is a block diagram illustrating an embodiment of a user configuration interface 550 that may be presented on a display device 504 to allow a user to configure a configurable emergency alert system. The user configuration interface includes a first text field 551 where the user may enter a first number where an emergency alert text message is to be sent, a second text field 552 where the user may enter a second number where the emergency alert text message is to be sent, and a third text field 553 where the user may enter a third number where the emergency alert text message is to be sent. Other embodiments may allow for more than three numbers or any desired number of additional numbers. Also included is a field 554 where the emergency alert text message may be entered.

The user configuration interface also includes a first phone field 555 where the user may enter a first number where an emergency alert phone or voice message is to be sent, a second phone field 556 where the user may enter a second number where the emergency alert phone or voice message is to be sent, and a third phone field 557 where the user may enter a third number where the emergency alert phone or voice message is to be sent. Other embodiments may allow for more than three numbers or any desired number of additional numbers. Moreover, other embodiments, rather than allowing for potentially/optionally different numbers for text and phone alerts, may use the same set of numbers for both text and phone alerts. Also included is a touchscreen button 558 that may be pressed to allow an emergency alert phone or voice message to be recorded.

In some embodiments, the user configuration interface may include a field 559 to specify whether or not position or location information of the mobile wireless device (e.g., from a GPS system) is to be automatically included in the text and phone emergency alert messages. Similarly, in some embodiments, the user configuration interface may include a field 560 to specify whether or not a current time from the mobile wireless device (e.g., from a timing unit) is to be automatically included in the text and phone emergency alert messages.

To further illustrate certain concepts, consider an example embodiment of an emergency alert text message 436 that a user may pre-configure and that may be sent to one or more pre-configured numbers. The following is one possible such text message, which may actually be sent as one or more text messages depending upon the allowed numbers of characters per text message:
YOU ARE GETTING THIS MESSAGE BECAUSE JOHN SMITH IS HAVING AN EMERGENCY. I NEED YOUR IMMEDIATE HELP!
MY CURRENT LOCATION IS: 1279 OAKMEAD PARKWAY, SUNNYVALE, CALIFORNIA
THE TIME IS: 7:37 PM PST ON FEB. 11
I AM ALLERGIC TO PEANUTS, AND THIS ALERT IS POSSIBLY (BUT NOT NECESSARILY) DUE TO UNINTENDED INGESTION.
I CURRENTLY TAKE THE MEDICINE ACEBUTOLOL.
MY PHYSICIAN IS DR. FRED JONES OF SUNNYVALE PHYSICIANS GROUP WHOSE NUMBER IS (408) 720-8300.
MY INSURANCE COMPANY IS OAKMEAD MEDICAL INSURANCE AND THEIR NUMBER IS (408) 720-8383. MY POLICY IS 123454321.
   As can be seen, the message includes a user-configurable message. This particular message includes details of location, time, medical conditions of the patient (e.g., allergic to peanuts), medicines taken (e.g., acebutolol), physician name and contact information, and insurance company information. Advantageously, the information may be pre-configured, which may help to prevent the user from needing to convey it verbally at the time of the event. Similar content may be included verbally in a phone or voice message. This is just one illustrative example of a suitable message. Other messages may include more or less information or detail. For example, other messages may be tailored, customized, or personalized to meet the individual user's particular expected emergency alert needs and/or her preferences.

To further illustrate certain concepts, consider a particular example embodiment of a use of a configurable emergency alert system. FIG. 6 illustrates an embodiment of operation 662 of a configurable emergency alert system. As shown, John Smith was having an asthma attack. He reached for his smartphone which has an embodiment of a configurable emergency alert system. He pressed on the icon of the emergency alert system which was displayed on the touchscreen. This triggered or caused the emergency alert system to initiate an emergency alert process. First, the smartphone sent out emergency alert text messages to all three phone numbers pre-configured in the emergency alert call list. These included his brother, his mother, and a private hospital. The emergency alert text messages included “S.O.S. call from John Smith. Current location: 1279 Oakmead Parkway, Sunnyvale. Time: 7:37 PM PST on Feb. 11.” After the three text messages were sent, the call flow started. First, the smartphone autonomously dialed his brother, who was the first configured number in the alert call list. After five rings, his brother did not answer, the alert process autonomously terminated the call. The smartphone autonomously dialed his mother, who was the second configured number in the alert call list. After three rings, his mother answered. A pre-recorded or configured voice message was delivered to his mother. It may include similar content to the aforementioned text message alert, or different content. Since the mother answered the call, the call flow process terminated. His mother was notified and was on the way to help him. This is just one illustrative example.

Components, features, and details described for FIG. 4 may also optionally be used in any of FIG. 1 or 3. Moreover, components, features, and details described herein for any of the apparatus may also optionally be used in any of the methods described herein, which in embodiments may be performed by and/or with such the apparatus. For example, components, features, and details described for either FIG. 2 or FIG. 6 may also optionally be used in any of FIG. 2 or FIG. 6. The interface of FIG. 5 may be used by any of the configurable emergency alert systems disclosed herein including those of either FIG. 3 or FIG. 4.

### Example Embodiments

The following examples pertain to further embodiments. Specifics in the examples may be used anywhere in one or more embodiments.

Example 1 is an emergency alert system. The emergency alert system includes an emergency alert system configuration module to allow a user to configure a phone number to which an emergency alert is to be sent. The emergency alert system also includes a touchscreen interface module to receive an indication from a user, through a touchscreen display device, that the emergency alert is to be sent. The emergency alert system also includes an emergency alert module coupled with the touchscreen interface module. The emergency alert module, in response to the indication, is to cause the emergency alert to be sent to the user configured phone number through a wireless signal that is to be transmitted by an antenna.

Example 2 includes the subject matter of Example 1 and optionally in which the emergency alert system configuration module is to allow the user to configure the phone number to be any valid phone number.

Example 3 includes the subject matter of any of Examples 1-2 and optionally in which the emergency alert system configuration module is to allow the user to configure the phone number to be any of at least a phone number of a friend, a phone number of a relative, and a phone number of a neighbor.

Example 4 includes the subject matter of any of Examples 1-3 and optionally in which the emergency alert system configuration module is to allow the user to configure the emergency alert to include content selected from a medical condition of the user, a medicine the user is taking, a health care provider of the user, contact information for the health care provider of the user, an insurance provider, contact information for the insurance provider, and an insurance policy number of the user.

Example 5 includes the subject matter of any of Examples 1-4 and optionally further including a module to autonomously include a location of the apparatus in the emergency alert.

Example 6 includes the subject matter of any of Examples 1-5 and optionally in which the emergency alert system configuration module is to allow the user to record an emergency alert voice message which is to be sent by the emergency alert module in response to the indication by the user.

Example 7 includes the subject matter of any of Examples 1-6 and optionally in which the emergency alert system configuration module is to allow the user to configure multiple different phone numbers, and in which the emergency alert module is to cause an emergency alert to be sent to each of the multiple user configured phone numbers.

Example 8 includes the subject matter of Example 7 and optionally in which the emergency alert module is to cause a call flow in which emergency alert phone calls are made in sequence and each to a different one of the different phone numbers.

Example 9 includes the subject matter of any of Examples 1-8 and optionally in which the emergency alert module is to cause the emergency alert to be sent to the user configured phone number as an emergency alert text message, and is to cause a second emergency alert to be sent to the user configured phone number as an emergency alert phone message.

Example 10 includes the subject matter of any of Examples 1-8 and optionally in which the touchscreen interface module is to present an icon for the emergency alert system on the touchscreen display device, and in which the icon when touched is to cause the emergency alert system to send the emergency alert to the user configured phone number.

Example 11 includes the subject matter of any of Examples 1-8 and optionally in which the touchscreen interface module is to receive the indication from the user based on the user pressing on the touchscreen for at least two seconds.

Example 12 includes the subject matter of any of Examples 1-8 and optionally in which the touchscreen interface module is to receive the indication from the user even when a mobile wireless device in which the emergency alert system is included is one of locked and in a sleep mode.

Example 13 is an emergency alert method that includes receiving input from a user through a touchscreen display device, and based on the input configuring a phone number to which an emergency alert is to be sent. The method also includes receiving an indication from the user, through the touchscreen display device, that the emergency alert is to be sent. The method also includes causing the emergency alert to be sent to the configured phone number through a wireless signal transmitted by an antenna in response to receiving the indication.

Example 14 includes the subject matter of Example 13 and optionally in which configuring the phone number includes configuring the phone number to be any valid phone number.

Example 15 includes the subject matter of Example 13 and optionally further including receiving input from the user to configure the emergency alert to include content selected from a medical condition of the user, a medicine the user is taking, a health care provider of the user, contact information for the health care provider of the user, an insurance provider, contact information for the insurance provider, and an insurance policy number of the user.

Example 16 includes the subject matter of any of Examples 13-15 and optionally further including autonomously including a location of the touchscreen display device in the emergency alert.

Example 17 includes the subject matter of any of Examples 13-15 and optionally including configuring multiple different phone numbers based on the input from the user. Further including causing an emergency alert to be sent to each of the multiple different phone numbers, in which causing the emergency alert to be sent to each of the multiple different phone numbers includes causing a call flow in which emergency alert phone calls are made in sequence and each to a different one of the multiple different phone numbers.

Example 18 includes the subject matter of any of Examples 13-15 and optionally in which receiving the input from the user includes receiving the input from the user by the user touching on the touchscreen display for at least two seconds.

Example 19 is an article of manufacture including a non-transitory machine-readable storage medium that provides instructions that, if executed by a machine, will cause the machine to perform operations including configuring a phone number to which an emergency alert is to be sent based on input from a user through a touchscreen display device. The operations also include receiving an indication from the user, through the touchscreen display device, that the emergency alert is to be sent. The operations also include causing the emergency alert to be sent to the configured phone number through a wireless signal transmitted by an antenna in response to receiving the indication.

Example 20 includes the subject matter of Example 19 and optionally in which the instructions to configure the phone number comprise instructions that if executed will cause the machine to configure the phone number to be any valid phone number.

Example 21 includes the subject matter of Example 19 and optionally further including instructions that if executed will cause the machine to configure the emergency alert to include content selected from a medical condition of the user, a medicine the user is taking, a health care provider of the user, contact information for the health care provider of the user, an insurance provider, contact information for the insurance provider, and an insurance policy number of the user.

Example 22 includes the subject matter of any of Examples 19-21 and optionally further including instructions that if executed will cause the machine to autonomously include a location in the emergency alert.

Example 23 includes the subject matter of any of Examples 19-21 and optionally further including instructions that if executed will cause the machine to configure multiple different phone numbers based on the input from the user and cause an emergency alert to be sent to each of the multiple different phone numbers.

Example 24 is a wireless emergency alert device including an antenna, and a wireless transceiver coupled with the antenna. The wireless transceiver is to transmit and receive wireless signals with the antenna. The device also includes a touchscreen display device to receive an indication from a user that an emergency alert is to be sent. The device also includes a configurable emergency alert system coupled with the touchscreen display device. The configurable emergency alert system is to cause the emergency alert to be sent to a user configured phone number through the wireless transceiver and the antenna based on an indication from the user that the emergency alert is to be sent.

Example 25 includes the subject matter of Example 24 and optionally in which the configurable emergency alert system is to allow the user configured phone number to be any valid phone number. Further optionally in which the configurable emergency alert system is to allow the user to configure the emergency alert to include content selected from a medical condition of the user, a medicine the user is taking, a health care provider of the user, contact information for the health care provider of the user, an insurance provider, contact information for the insurance provider, and an insurance policy number of the user.

Example 26 includes a mobile wireless device to perform the method of any of Examples 13-18.

Example 27 includes a mobile wireless device including means for performing the method of any of Examples 13-18.

Example 28 includes a non-transitory machine-readable storage medium storing instructions that if executed by a machine are to cause the machine to perform the method of any of Examples 13-18.

Example 29 includes an apparatus to perform any of the operations or methods described herein.

Example 30 includes an apparatus including means for performing any of the operations or methods described herein.

Example 31 includes an emergency alert system including means for receiving input from a user through a touchscreen display device and based on the input configuring a phone number to which an emergency alert is to be sent. The system also includes means for receiving an indication from the user, through the touchscreen display device, that the emergency alert is to be sent. The system also includes means for causing the emergency alert to be sent to the configured phone number through a wireless signal transmitted by an antenna in response to receiving the indication.

Example 32 includes the emergency alert system of Example 31 and optionally in which the means for causing comprises means for configuring the phone number to be any valid phone number.

Example 33 includes the emergency alert system of any of claims 13-18, and optionally further comprising presenting an icon for the emergency alert system on the touchscreen display device.

Example 34 includes the emergency alert system of any of claims 13-18, and optionally further comprising touching the icon to cause the emergency alert system to send the emergency alert to the user configured phone number.

Example 35 includes the emergency alert system of any of claims 13-18, and optionally further comprising receiving the indication from the user even when a mobile wireless device is one of locked and in a sleep mode.

In the description and claims, the terms “coupled” and “connected,” along with their derivatives, may have been used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. For example, a module may be coupled with a wireless modem or antenna through one or more intervening modules, components, etc. In the figures, arrows are used to show connections and couplings.

In the description and claims, the term “logic” may have been used. As used herein, logic may include hardware, firmware, software, or a combination thereof. Examples of logic include integrated circuitry, application specific integrated circuits, analog circuits, digital circuits, programmed logic devices, memory devices including instructions, etc.

The term “and/or” may have been used. As used herein, the term “and/or” means one or the other or both (e.g., A and/or B means A or B or both A and B).

In the description above, for purposes of explanation, numerous specific details have been set forth in order to provide a thorough understanding of embodiments of the invention. It will be apparent however, to one skilled in the art, that one or more other embodiments may be practiced without some of these specific details. The particular embodiments described are not provided to limit the invention but to illustrate it through example embodiments. The scope of the invention is not to be determined by the specific examples but only by the claims. In other instances, well-known circuits, structures, devices, and operations have been shown in block diagram form or without detail in order to avoid obscuring the understanding of the description.

Where considered appropriate, reference numerals, or terminal portions of reference numerals, have been repeated among the figures to indicate corresponding or analogous elements, which may optionally have similar or the same characteristics, unless specified or clearly apparent otherwise. In some cases, where multiple components have been described, they may be incorporated into a single component. In other cases, where a single component has been described, it may be partitioned into multiple components.

Various operations and methods have been described. Some of the methods have been described in a relatively basic form in the flow diagrams, but operations may optionally be added to and/or removed from the methods. In addition, while the flow diagrams show a particular order of the operations according to example embodiments, that particular order is exemplary. Alternate embodiments may optionally perform the operations in different order, combine certain operations, overlap certain operations, etc.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, one or more instructions, that if and/or when executed by a machine are operable to cause the machine to perform and/or result in the machine performing one or operations, methods, or techniques disclosed herein.

In some embodiments, the machine-readable medium may include a tangible and/or non-transitory machine-readable storage medium. For example, the tangible and/or non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In another embodiment, the machine-readable medium may include a transitory machine-readable communication medium, for example, the electrical, optical, acoustical or other forms of propagated signals, such as carrier waves, infrared signals, digital signals, or the like. In one embodiment, an emergency alert system or modules thereof may be downloaded over a transitory machine-readable communication medium.

Examples of suitable machines include, but are not limited to, general-purpose processors, special-purpose processors, instruction processing apparatus, digital logic circuits, integrated circuits, and the like. Still other examples of suitable machines include computing devices and other electronic devices that incorporate such processors, instruction processing apparatus, digital logic circuits, or integrated circuits. Examples of such computing devices and electronic devices include, but are not limited to, smartphones, cellular phones, tablets, netbooks, notebooks, laptops, Mobile Internet devices (MIDs), other types of mobile wireless devices, and other electronic devices. Such electronic devices typically include one or more processors coupled with one or more other components, such as one or more non-transitory machine-readable storage media, user input/output devices (e.g., a keyboard, a touchscreen, a wireless modem).

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

1-25. (canceled)

26. An emergency alert system comprising:
an emergency alert system configuration module to allow a user to configure a phone number to which an emergency alert is to be sent;
a touchscreen interface module to receive an indication from a user, through a touchscreen display device, that the emergency alert is to be sent; and
an emergency alert module coupled with the touchscreen interface module, the emergency alert module in response to the indication to cause the emergency alert to be sent to the user configured phone number through a wireless signal that is to be transmitted by an antenna.

27. The emergency alert system of claim 26, wherein the emergency alert system configuration module is to allow the user to configure the phone number to be any valid phone number.

28. The emergency alert system of claim 26, wherein the emergency alert system configuration module is to allow the user to configure the phone number to be any of at least a phone number of a friend, a phone number of a relative, and a phone number of a neighbor.

29. The emergency alert system of claim 26, wherein the emergency alert system configuration module is to allow the user to configure the emergency alert to include content selected from a medical condition of the user, a medicine the user is taking, a health care provider of the user, contact information for the health care provider of the user, an insurance provider, contact information for the insurance provider, and an insurance policy number of the user.

30. The emergency alert system of claim 26, further comprising a module to autonomously include a location of the apparatus in the emergency alert.

31. The emergency alert system of claim 26, wherein the emergency alert system configuration module is to allow the user to record an emergency alert voice message which is to be sent by the emergency alert module in response to the indication by the user.

32. The emergency alert system of claim 26, wherein the emergency alert system configuration module is to allow the user to configure multiple different phone numbers, and wherein the emergency alert module is to cause an emergency alert to be sent to each of the multiple user configured phone numbers.

33. The emergency alert system of claim 32, wherein the emergency alert module is to cause a call flow in which emergency alert phone calls are made in sequence and each to a different one of the different phone numbers.

34. The emergency alert system of claim 26, wherein the emergency alert module is to cause the emergency alert to be sent to the user configured phone number as an emergency alert text message, and is to cause a second emergency alert to be sent to the user configured phone number as an emergency alert phone message.

35. The emergency alert system of claim 26, wherein the touchscreen interface module is to present an icon for the emergency alert system on the touchscreen display device, and wherein the icon when touched is to cause the emergency alert system to send the emergency alert to the user configured phone number.

36. The emergency alert system of claim 26, wherein the touchscreen interface module is to receive the indication from the user based on the user pressing on the touchscreen for at least two seconds.

37. The emergency alert system of claim 26, wherein the touchscreen interface module is to receive the indication from the user even when a mobile wireless device in which the emergency alert system is included is one of locked and in a sleep mode.

38. An emergency alert method comprising:
receiving input from a user through a touchscreen display device and based on the input configuring a phone number to which an emergency alert is to be sent;
receiving an indication from the user, through the touchscreen display device, that the emergency alert is to be sent; and
causing the emergency alert to be sent to the configured phone number through a wireless signal transmitted by an antenna in response to receiving the indication.

39. The emergency alert method of claim 38, wherein configuring the phone number comprises configuring the phone number to be any valid phone number.

40. The emergency alert method of claim 38, further comprising receiving input from the user to configure the emergency alert to include content selected from a medical condition of the user, a medicine the user is taking, a health care provider of the user, contact information for the health care provider of the user, an insurance provider, contact information for the insurance provider, and an insurance policy number of the user.

41. The emergency alert method of claim 38, further comprising autonomously including a location of the touchscreen display device in the emergency alert.

42. The emergency alert method of claim 38, further comprising:
configuring multiple different phone numbers based on the input from the user; and
causing an emergency alert to be sent to each of the multiple different phone numbers, wherein causing the emergency alert to be sent to each of the multiple different phone numbers comprises causing a call flow in which emergency alert phone calls are made in sequence and each to a different one of the multiple different phone numbers.

43. The emergency alert method of claim 38, wherein receiving the input from the user comprises receiving the input from the user by the user touching on the touchscreen display for at least two seconds.

44. An article of manufacture comprising a non-transitory machine-readable storage medium that provides instructions that, if executed by a machine, will cause the machine to perform operations including:
configuring a phone number to which an emergency alert is to be sent based on input from a user through a touchscreen display device;
receiving an indication from the user, through the touchscreen display device, that the emergency alert is to be sent; and
causing the emergency alert to be sent to the configured phone number through a wireless signal transmitted by an antenna in response to receiving the indication.

45. The article of manufacture of claim 44, wherein the instructions to configure the phone number comprise instructions that if executed will cause the machine to configure the phone number to be any valid phone number.

46. The article of manufacture of claim 44, further comprising instructions that if executed will cause the machine to configure the emergency alert to include content selected from a medical condition of the user, a medicine the user is taking, a health care provider of the user, contact information for the health care provider of the user, an insurance provider, contact information for the insurance provider, and an insurance policy number of the user.

47. A wireless emergency alert device comprising:
an antenna;
a wireless transceiver coupled with the antenna, the wireless transceiver to transmit and receive wireless signals with the antenna;
a touchscreen display device to receive an indication from a user that an emergency alert is to be sent; and
a configurable emergency alert system coupled with the touchscreen display device, the configurable emergency alert system to cause the emergency alert to be sent to a user configured phone number through the wireless transceiver and the antenna based on an indication from the user that the emergency alert is to be sent.

48. The wireless emergency alert device of claim 47, wherein the configurable emergency alert system is to allow the user configured phone number to be any valid phone number, and wherein the configurable emergency alert system is to allow the user to configure the emergency alert to include content selected from a medical condition of the user, a medicine the user is taking, a health care provider of the user, contact information for the health care provider of the user, an insurance provider, contact information for the insurance provider, and an insurance policy number of the user.
